(19) United States
(12) Patent Application Publication
(10) Pub. No.: US 2016/0117301 A1
(43) Pub. Date: Apr. 28, 2016

(54) ANNOTATION SHARING SYSTEM AND METHOD

(71) Applicant: Fu-Chieh CHAN, New Taipei City (TW)

(72) Inventor: Fu-Chieh CHAN, New Taipei City (TW)

(21) Appl. No.: 14/521,479

(22) Filed: Oct. 23, 2014

(51) Int. Cl. G06F 17/24; H04L 29/08; H04L 29/06; G06F 3/0483; G06F 3/0484

(52) U.S. Cl. CPC G06F 17/241; G06F 3/0483; G06F 3/0484; H04L 65/403; H04L 67/06; H04L 67/10

(57) ABSTRACT

An annotation sharing system includes an annotation database and an annotation management server. The annotation database stores electronic annotation files. Each electronic annotation file associated with a note author identification and an electronic book identification, and includes data entries of various data types. The annotation management server displays the electronic annotation files together with the associated note author identifications and relevant information of the electronic books to a client device, and receives a download request for the electronic annotation files from the client device. The annotation management server provides a first graphical user interface to the client device for displaying the electronic annotation file with the associated electronic book file, and each data entry in the electronic annotation files is represented with a customized visual cue. The annotation management server also provides a second graphical interface to the client device for creating and editing the electronic annotation files.

### BACKGROUND

1. Field of Invention

The present disclosure relates to an annotation sharing system and method. More particularly, the present disclosure relates to an electronic annotation sharing system and method.

2. Description of Related Art

Making annotation helps learners engage in active reading. Moreover, annotations of experienced learners provide insight into and facilitate understanding of content of books. However, sharing annotation is difficult in the old days for paper books are the major format of books.

Recently, electronic book files are gaining popularity for its reduced weight and size, easy access and distribution, capability to incorporate multimedia content, and eco-friendliness. Devoted e-book readers are developed by major companies and become more and more affordable. The function of annotating the electronic book files is almost a must-have function on the e-book readers. However, the annotation is still mainly for personal use.

### SUMMARY

An aspect of the present disclosure is directed to an annotation sharing system. The annotation sharing system includes an annotation database and an annotation management server. The annotation database stores multiple electronic annotation files. Each electronic annotation file is associated with a note author identification and an electronic book identification, and includes data entries of various data types. The annotation management server is electrically connected to the annotation database and a client device. Moreover, the annotation management server executes software to perform the following operations: providing a visual representation of the electronic annotation files together with the note author identifications and the relevant information of the electronic book identified by the electronic book identifications associated with the electronic annotation files to the client device; receiving a download request from the client device for one or more of the electronic annotation files; providing a first graphical user interface to the client device for displaying the electronic annotation files associated with the same electronic book identification and an electronic book file identified by the electronic book identification associated with the electronic annotation files with each data entry in the electronic annotation files represented with a customized visual cue according to the data type of the data entry; and providing a second graphical interface to the client device for creating and editing the electronic annotation files.

Another aspect of the present disclosure is directed to an annotation sharing method. The annotation sharing method includes storing multiple electronic annotation files in an annotation database. Each electronic annotation file is associated with a note author identification and an electronic book identification, and includes data entries of various data types. The operations of the annotation sharing method also includes providing a visual representation of the electronic annotation files together with the note author identifications and relevant information of the electronic book identified by the electronic book identifications associated with the electronic annotation files to the client device, receiving a download request from the client device for one or more of the electronic annotation files, providing a first graphical user interface to the client device for displaying the electronic annotation files with the associated the electronic book file identified by the same electronic book identification associated with each data entry in the electronic annotation files represented with a customized visual cue according to the data type of the data entry, and providing a second graphical interface to the client device for creating and editing the electronic annotation files.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of an annotation sharing system according to a first embodiment of the present disclosure;

FIG. 2 illustrates an example of a first graphical user interface of the annotation sharing system according to the first embodiment of the present disclosure;

FIG. 3 illustrates an example of a second graphical user interface of the annotation sharing system according to the first embodiment of the present disclosure;

FIG. 4 illustrates an example of a first graphical user interface of the annotation sharing system according to a second embodiment of the present disclosure;

FIG. 5 illustrates an example of a second graphical user interface of the annotation sharing system according to the second embodiment of the present disclosure; and

FIG. 6 is a flow chart of an annotation sharing method according to a second embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

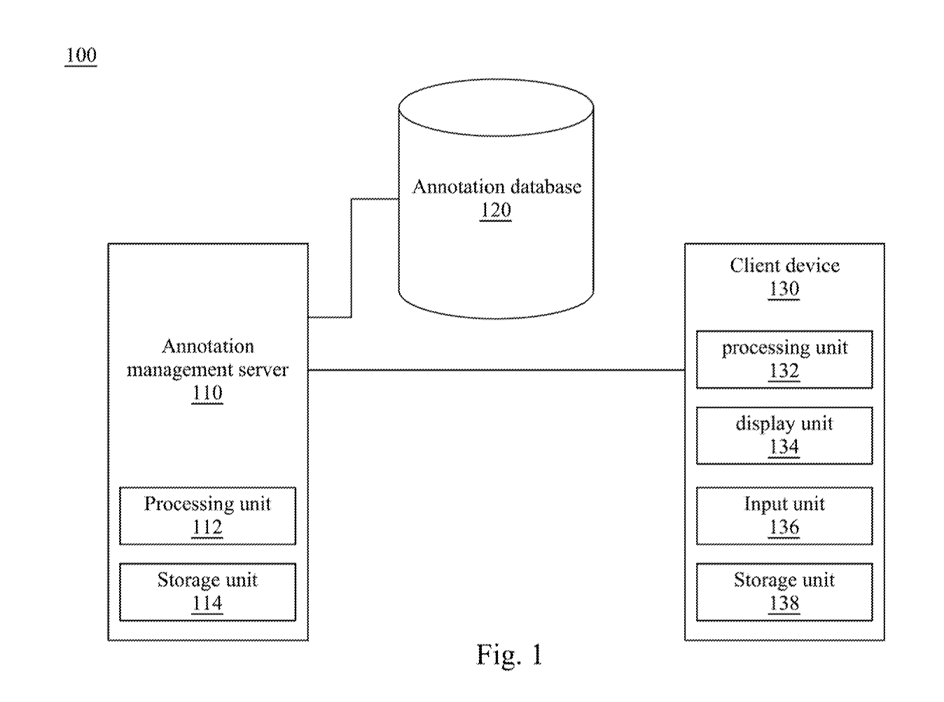

FIG. 1 is a schematic diagram of an annotation sharing system according to a first embodiment of the present disclosure. The annotation sharing system 100 provides a platform for users to obtain electronic annotation files created by other users and upload electronic annotation files compiled by themselves. An electronic annotation file includes multiple data entries of various data types, and each data entry is associated with different locations of the electronic book files, such as pages, to enable a matched display of the electronic annotation files with their associated electronic book files. The variety of data types helps multi-modal learning for all kinds of reading materials. The annotation sharing system 100 also enables readers of the same book to share their understanding and reading experience with their peers, and thus improves efficiency of knowledge acquisition. The annotation sharing system 100 further offers a channel for selling the electronic annotation files to provide incentives for experienced learners to compile quality electronic annotation files to help other learners.

The annotation sharing system 100 includes an annotation management server 110, an annotation database 120, and a client device 130. The annotation database 120 stores multiple electronic annotation files associated with different books and compiled by multiple note authors, and each of the electronic annotation file is associated with a note author identification and an electronic book identification. Each of the electronic annotation files includes data entries of various data types, such as comment, summary, illustration, etc. A user operates the client device 130 to access the annotation management server 110 to obtain a visual representation of the electronic annotation files stored in the annotation database 120 to the client device 130, so as to enable the user to select the electronic annotation file he/she is interested in. The user also obtains graphical user interfaces for viewing the electronic annotation files together with the electronic book files, and creating/editing new electronic annotation files.

In one embodiment, the note author identification is a username or an identification number of a user account, and the electronic book identification is ISBN (International Standard Book Number). In another embodiment, the annotation sharing system 100 creates unique electronic book identifications for books in the annotation database 120 for privately published books without ISBN.

The annotation management server 110 includes a processing unit 112 and a storage unit 114, and is electrically connected to the annotation database 120 to access the electronic annotation files. The client device 130 is connected to the annotation management server 110 to access the annotation database 120 through graphical user interfaces provided by the annotation management server 110.

In some embodiments, the annotation management server 110 is a personal computer, a server, or a workstation. The processing unit 112 is a microprocessor, and the storage unit 114 is a non-transitory computer readable storage medium, e.g., a hard disk, a solid-state disk, or an optical disc. In another embodiment, the annotation database 120 is a cloud database for the annotation management server 110 to access via a network. In another embodiment, the annotation database 120 is a database stored locally in a non-transitory computer readable storage medium of the annotation management server 110.

The client device 130 includes a processing unit 132, a display unit 134, an input unit 136, and a storage unit 138. In one embodiment, the client device 130 is a smart phone; the processing unit 132 is a microprocessor; the display unit 134 and the input unit 136 are combined as a touch panel; and the storage unit 138 is a flash memory. In another embodiment, the client device 130 is a personal computer; the processing unit 132 is a central processing unit; the display unit 134 is an LED monitor; the input unit 136 is a mouse and a keyboard; and the storage unit 138 is a hard disk.

The annotation management server 110 utilizes the processing unit 112 to execute software stored on the storage unit 114 to provide a visual representation of the electronic annotation files together with the note author identifications and relevant information of the electronic book identified by the electronic book identifications associated with the electronic annotation files to the client device 130. The user operates the client device 130 to adjust the visual representation, such as ordering the electronic annotation files according to the relevant information of the electronic book identified by the electronic book identifications associated with the electronic annotation files.

In one embodiment, the visual representation is similar to bookshelves in a book store, which means the visual representation first displays titles and cover image of the electronic book files associated with the electronic annotation files categorized by topics, and the electronic annotation files in each category are further arranged in the alphabetical order of the last names of the authors. The user operates the client device 130 to select one of the electronic books, and then the list of electronic annotation files associated with the selected electronic book is displayed.

In another embodiment, the user inputs a note author identification filter rule including a list of note author identifications, and the annotation management server 110 receives the note author identification filter rule to adjust the visual representation of the electronic annotation files. This enables the user to view the electronic annotation files compiled by certain note authors in the list, and these note authors share the same reading interests with the user or are experienced learners in the field that the user is interested in.

In yet another embodiment, the user inputs a note author identification subscription list including multiple note author identifications by operating the client device 130, and the annotation management server 110 notifies the user when any of the note authors in the subscription list uploads new electronic annotation files to the annotation database 120 with emails, messaging apps (e.g., Whatsapp), or SMS, etc.

The user views the visual representation of the electronic annotation files with the display unit 134, and sends a download request to the annotation management server 110 when he/she intends to download one or more of the electronic annotation files. The annotation management server 110 receives the download request, and check whether the annotation files associated with the download request are priced or free. When the annotation files are free, the annotation management server 110 starts the download process and adds the electronic annotation files to a collection of the user. When the electronic annotation file is priced, the annotation management server 110 displays a document form to the client device 130, e.g., an HTML form. The user fills in the payment information, e.g., credit card numbers, or online payment account information. The annotation management server 110 verifies the payment information or submits the payment information to an external server (not shown in the figure) for verification. After the payment information passes the verification, the annotation management server 110 starts the download process of the electronic annotation files and adds them to the collection of the user.

In one embodiment, the electronic annotation files in the collection of the user are stored in the storage unit 138 of the client device 130, and the annotation management server 110 keeps a list of reference to the electronic annotation files in the collection of the user on the storage unit 114. When the user utilizes a different client device 130 to connect to the annotation management server 110, the annotation management server 110 allows the user to download the electronic annotation files in the list of reference again.

When the user intends to read an electronic book together with the electronic annotation files in his/her collection, the annotation management server 110 provides a first graphical user interface to the client device 130 for displaying the electronic annotation files and an electronic book file with the same electronic book identification, and the data entries in the electronic annotation file are represented with customized visual cues according to the data types of the data entries.

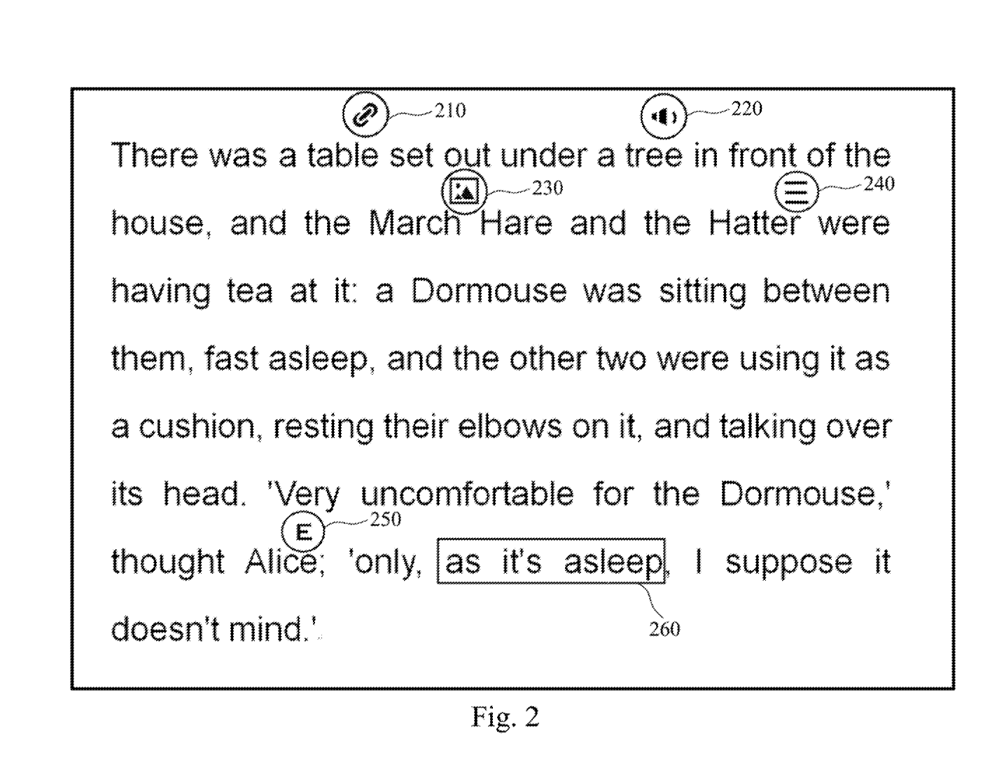

FIG. 2 illustrates an example of the first graphical user interface of the annotation sharing system 100 according to the first embodiment of the present disclosure, and particularly illustrates a book content page and how the first graphical user interface utilizes customized visual cues to display page data entries included in the data entries. Each of the page data entries is associated with a location in the electronic book file, and the data types for the page data entries include image, audio, text, highlight, web link, and error correction. The customized visual cues indicate the data types and the locations of the page data entries.

In the present embodiment, the customized visual cues for the page data entries 210-250 are icons placed between the lines, and the customized visual cue for the page data entry 260 is color overlaying on a text segment (outlined in a rectangle as shown) of the book content page. The page data entries 210-260 are of different data types, and each data type is associated with different icons. The data type of the page data entry 210 is web link; the data type of the page data entry 220 is audio; the data type of the page data entry 230 is image; the data type of the page data entry 240 is text; the data type of the page data entry 250 is error correction; the data type of the page data entry 260 is highlight. Designs of the icons 210-250 are just by examples, and the scope of the present disclosure should not be limited hereto. The user operates the client device 130 to click on the icons, and the first graphical user interface renders the content of the associated page data entries in a new annotation content page overlaying on the book content page or in a pop-up window overlaying on the book content page. In another embodiment, the book content page is divided into two portions with one portion displaying the original book content and the other displaying content of the page data entry. Those skilled in the art can design how to render the content of the page data entries according to application scenarios and user preference without departing from the spirit and scope of the present disclosure.

In some embodiments, the color overlaying the text of the book content page is related to the number of page data entries of highlight. A reference table of color and a ratio of the number the electronic annotation files with a page data entry highlighting a text segment to a total number of the electronic annotation files associated with the displayed electronic book is given in the blank space of the book content page. The user tells which part of the book content page is of higher importance by the color overlaying on the text of the book content page.

In another embodiment, the annotation management server 110 adjusts the first graphical user interface to selectively display part of the electronic book file associated with the page data entries of the data type of highlight. To be more specific, the user operates the client device 130 to switch the first graphical user interface into a digest mode, and the annotation management server 110 displays only the highlighted text. In yet another embodiment, the user further inputs a threshold value of the ratio, and the annotation management server 110 displays the part of the texts associated with the ratio of the number of page data entries highlighting the texts to the total number of electronic annotation files associated with the displayed electronic book higher than the threshold value. For example, when red means 75-100% of the electronic annotation files have the page data entry of highlight for this text segment, purple means 50-75%, and blue means 25-50%, and the user inputs the threshold value as 50%, the annotation management server 110 adjusts the first graphical user interface to display the texts overlaid with purple and red in the first graphical user interface. The color and figures provided are by examples, and the scope of the present disclosure is not limited hereto.

In yet another embodiment, the customized visual cue for the page data entries of different data types is color. A reference table of the data types and the associated colors is given in the blank space of the book content page. Using color as the customized visual cue is suitable when the user prefers to view the book content page with single line spacing, thus no room for the icons. Moreover, the data type of highlight is represented with grayscale shade overlaying on the text of the book content page in which the intensity of the grayscale indicates the ratio of the number of the electronic annotation files with page data entries highlighting the text to the number of all electronic annotation files associated with the displayed electronic book. Those skilled in the art can design how to display the page data entries according to application scenarios and user preference without departing from the spirit and scope of the present disclosure.

The annotation management server 110 provides the first graphical user interface to the client device 130, so as to enable the user to read the electronic book together with the electronic annotation files, which complements the content of the electronic book. When the user finds the electronic annotation file helpful, the user operates the client device 130 to rate the electronic annotation file by sending a score associated with the electronic annotation file to the annotation management server 110. The annotation management server 110 stores the score together with the electronic annotation file for reference for other users. The rating mechanism promotes the electronic annotation files useful for learning.

In some embodiments, the annotation management server 110 receives a rating filter rule to adjust the visual representation of the electronic annotation files according to the scores associated with the electronic annotation files. For example, the user inputs the rating filer rule as a threshold value for the average score, the annotation management server 110 adjusts the visual representation to display the electronic annotation files with the average scores higher than the threshold value. The rating filter rule can also be a threshold value for accumulative scores, then the annotation management server 110 adjusts the visual representation to display the electronic annotation files with the accumulative scores higher than the threshold value.

In another embodiment, the scores for the electronic annotation files are utilized in the first graphical interface when the user has multiple electronic annotation files associated with one electronic book and finds the display of the book content page cluttered. The user operates the client device 130 to input a rating filter rule to adjust the first graphical user interface to display the data entries of the electronic annotation files with scores higher than a threshold value associated with the rating filter rule input by the user.

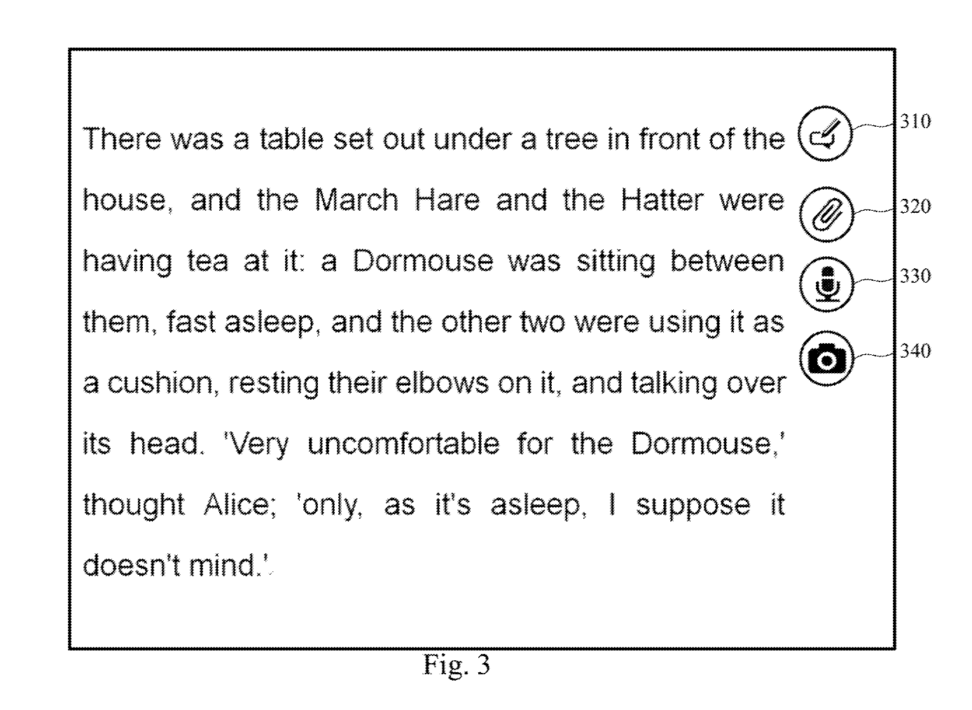

The annotation management server 110 also provides a second graphical user interface to the client device 130 for creating and editing the electronic annotation files. FIG. 3 illustrates an example of a second graphical user interface of the annotation sharing system 100 according to the first embodiment of the present disclosure. The icons 310-340 are part of the second user interface for creating page data entries at different locations of the electronic book. The user operates the client device 130 to click the specific location he/she intends to add a page data entry, and then click on one of the icons 310-340 to insert the page data entries of the associated data types. The icon 310 represents inserting a page data entry of text. The icon 320 represents inserting a page data entry of web link. The icon 330 represents inserting a page data entry of audio. The icon 340 represents inserting a page data entry of image.

In some embodiments, the user clicks on the icons 310-340 to type text, insert a web link, and select a file of audio and image, respectively. In another embodiment, the user clicks on the icons 330 to activate the microphone of the client device 130, and record a voice segment as the content of the page data entry of the data type of audio. In yet another embodiment, the user clicks on the icon 340 to activate the camera of the client device 130, and captures an image as the content of the page data entry, or launches a graphic painting program, such as Paint, Paint.NET, or illustrator, to draw illustrations or mind maps to enhance the effect of learning.

The variety of the data types facilitates learning in different fields and for learners with different learning styles. For example, the data entries of audio help study for languages or music, and the data entries of image help the understanding of handcraft related books in which information is missing between the pictures of two consecutive steps. Moreover, visual learners benefit from the page data entries of image, and audio learners benefit from the page data entries of audio.

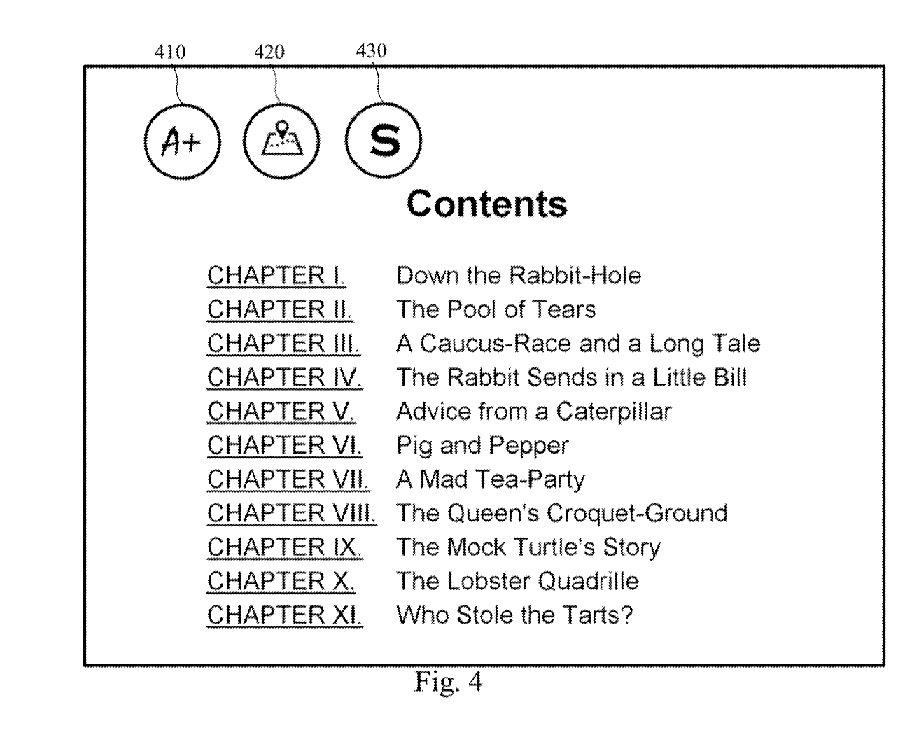

FIG. 4 illustrates an example of a first graphical user interface of the annotation sharing system according to a second embodiment of the present disclosure. Besides the page data entries respectively associated with specific locations of the electronic book files, the data entries also include general data entries with different data types including summary, comment, learning map, and sample question. The general data entries are associated with the electronic book as a whole instead of a specific location. FIG. 4 illustrates the general data entries 410-430.

The general data entry 410 is of the data type of sample question, which are sample questions compiled by experienced learners from other textbooks or questions in past exams. The general data entry 420 is of the data type of learning map, which includes a preliminary reading list and an extended reading list. The preliminary reading list directs users who start reading the electronic book file without foundations of the prerequisite materials to understand the electronic book. The extended reading list directs the users who finish reading the electronic book file but want to learn more advanced materials. The general data entry 430 is of the data type of summary, which includes a summary of the electronic book. The general data entries also include the data type of comment as the page data entries, which enables users to freely add comments that the user deems relevant, such as keyword, thoughts provoked by the content, or even pseudo code or code segments for electronic book files related to programming.

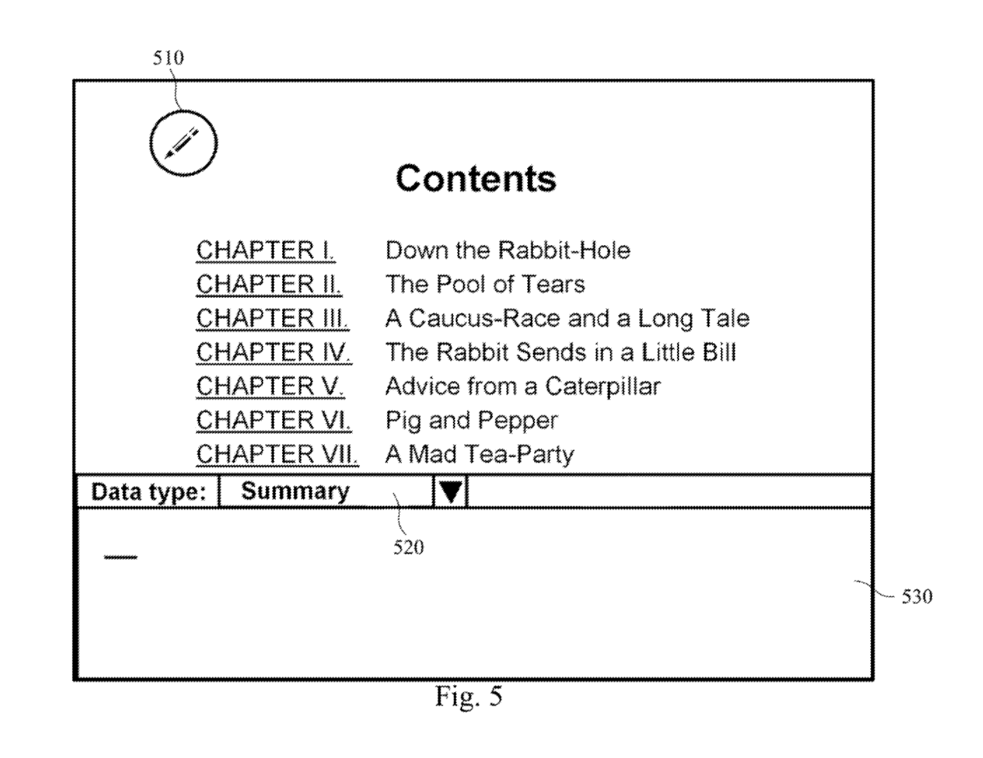

FIG. 5 illustrates an example of a second graphical user interface of the annotation sharing system 100 according to the second embodiment of the present disclosure. The client device 130 displays the second graphical user interface including an editing icon 510. The user operates the client device 130 to click on the editing icon 510 to open an editing window 520 in the bottom portion of the second graphical interface. The editing window 520 further includes a drop down menu 530 for selecting the data type of the data entries that the user intends to insert into the electronic annotation file. The second graphical user interface illustrated in FIG. 5 is suitable for the client device 130 with the display unit 134 in a small size, and thus no room for individual icon for each data type of the data entries.

The annotation sharing system 100 enables users, or readers, to share and exchange their reading experiences with people who are also interested in the same electronic book. The annotation sharing system 100 also provides a channel for authors of the electronic book files to obtain feedback of the readers, such as which parts of the electronic book files cause understanding difficulties, and which parts of the electronic book files are regarded as important. If there is any error in a published electronic book, the annotation sharing system 100 facilitates a prompt error correction.

The annotation sharing system 100 also provides compatibility with paper books. When the user owns a paper copy of the electronic book associated with the electronic book identification and intends to look up the page data entries of a specific location in the electronic annotation files associated with the electronic book, the user sends a lookup request to the annotation management server 110. Specifically, the user who intends to read the page data entries associated with a page in the paper book takes a picture of the page as a page image, and sends the lookup request including the electronic book identification and the page image to the annotation management server 110. The annotation management server 110 recognizes the content of the page image with machine vision, e.g., OCR (Optical Character Recognition) technology, identifies the location of the page in the electronic book with the electronic book identification, and retrieves the page data entries of the electronic annotation files associated with the electronic book identification in the lookup request. Illustratively, the annotation sharing system 100 enables users with both electronic book files and paper books to access the knowledge shared in the electronic annotation files.

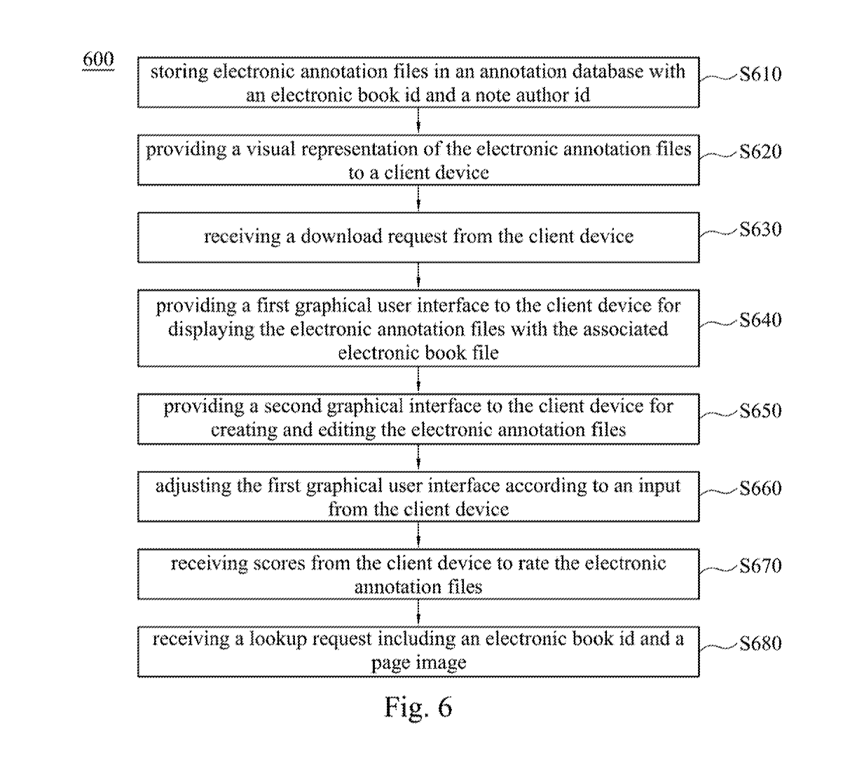

FIG. 6 is a flow chart of an annotation sharing method according to a second embodiment of the present disclosure. For convenience and clarity of understanding, the descriptions for the annotation sharing method 600 takes the annotation sharing system 100 as an example, but the disclosure is not limited hereto. While the process flow described below includes a number of operations that appear to be in a specific order, it should be apparent that these operations may include more or fewer operations, which may be executed serially or in parallel (e.g., using parallel processors or in a multi-threading environment).

In operation S610, electronic annotation files are stored in an annotation database 120, and each electronic annotation file is associated with an electronic book identification and a note author identification. The electronic annotation files include multiple data entries of different data types. In one embodiment, the data entries include page data entries, chapter data entries, and general data entries, which are associated with different levels of the book. The details of the page data entries and the general data entries are given in the accompanying text of FIG. 2 and FIG. 4, and not repeated herein. The chapter data entries are associated with each chapter in the electronic book, and also include the data types of summary, comment, sample questions, and other data types included in the page data entries as well.

In operation S620, a visual representation of the electronic annotation files is provided to a client device 130. The visual representation serves as a virtual bookshelf displaying the electronic annotation files stored in the annotation database 120 for the user to choose. The visual representation is adjustable according to filter rules input by the user of the client device 130. The user inputs a note author filter rule to view the electronic annotation files compiled by the note authors in the list of note author identifications specified in the note author filter rule.

In operation S630, the user chooses one or more of the electronic annotation files, the annotation management server 110 receives a download request for the chosen electronic annotation files from the client device 130. The annotation management server 110 processes the download request according to whether the electronic annotation files are free. When the electronic annotation files are free, the annotation management server 110 starts the download process automatically. When the electronic annotation files are priced, the annotation management server 110 receives payment information from the client device. The details of processing the payment information are given in the previous paragraphs, and not repeated herein.

In operation S640, a first graphical user interface is provided to the client device 130 for displaying the data entries of the electronic annotation files with the associated electronic book foe. The page data entries included in the data entries are displayed at the associated locations with the customized visual cues, such as icons and colors, according to the data types of the page data entries. The chapter data entries included in the data entries are displayed below or above the chapter headings with the customized visual cues, such as icons, according to the data types of the general data entries. The general data entries included in the data entries are displayed along with the table of content of the electronic book with the customized visual cues, such as icons, according to the data types of the general data entries. The details of displaying the electronic annotation file together with the electronic book files are similar to the description in the accompanying texts of FIG. 2 and FIG. 4, and not repeated herein.

In operation S650, a second graphical user interface is provided to the client device 130 for creating and editing the electronic annotation files. In one embodiment, the second graphical user interface provides editing icons for individual data types, and the user operates the client device 130 to click on one of the editing icons to insert content of the data entries by typing words, attaching files, recording voices, drawing illustrations, or taking pictures. In another embodiment, the second graphical user interface provides a single editing icon for all data types, and the user clicks on the editing icon to open an editing window for selecting the data types and inserting content of data entries in the electronic annotation file.

In operation S660, the first graphical user interface is adjusted according to an input from the client device 130. In one embodiment, the user inputs a signal to switch the first graphical user interface into a digest mode to display part of the electronic book files associated with the page data entries of the data type of highlight. In another embodiment, the user inputs filter rules with the client device 130 to adjust the first graphical user interface, so as to avoid cluttered display of the data entries in the electronic annotation files. The filter rules includes note author filter rules including a list of note author identifications, and the first graphical user interface displays the data entries of the electronic annotation files associated with the note author identifications specified in the list. In yet another embodiment, the user inputs a level filter rule. The data entries in the electronic annotation files are in a hierarchical data structure including three levels, the page data entries, the chapter data entries, and the general data entries. The user hides the data entries associated with a certain level in the display by inputting the level filter rule including a list of levels. The adjustability of the first graphical user interface enables the user to customize the view while reading the electronic book files according to his/her preference.

In operation S670, scores from the client device 130 are received to rate the electronic annotation files. The rating mechanism helps the user to evaluate the quality of the electronic annotation files, so as to promote quality electronic annotation files with positive reception. The scores for the electronic annotation files are also used in adjusting the visual representation and the first graphical user interface. The user inputs a rating filter rule to adjust the visual representation and the first graphical user interface to display the electronic annotation files with scores higher than a threshold value specified in the rating filter rule. The details of the rating filter rule are given in the previous paragraphs, and not repeated herein.

In operation S680, a lookup request including an electronic book identification and a page image is received and processed. When the user owns a paper copy of the electronic book associated with the electronic book identification and intends to look up the page data entries associated with a specific location in the electronic annotation files associated with the electronic book, the user sends a lookup request to the annotation management server 110. The user scans or takes a picture of a page in the paper book to be the page image, and the lookup request includes the electronic book identification and the page image. The page image is processed with machine vision such as OCR technology for recognizing the content of the page image, and the location of the electronic book file associated with the page image is identified. The page data entries associated with the location are displayed on the display unit 134 of the client device 130. The operation S680 is to provide compatibility with paper books, and enables paper book owner to access the electronic annotation files.

In some embodiments, the operations S640-S680 are performed by the processing unit 132 executing software stored in the storage unit 138, so as to add flexibility by allowing the user to view and edit the electronic annotation files while the client device 130 is unconnected to the annotation management server 110. The annotation management server 110 synchronizes the electronic annotation files stored in the storage unit 138 when connected to the client device 130.

For authors, the annotation sharing system 100 and the annotation sharing method 600 in the present disclosure provide a channel to gather feedback from the readership and interact with the readers. Moreover, the electronic annotation files shared also provide teachers the information of common understanding difficulties, and the teachers design the class to focus on the difficult parts. To sum up, the annotation sharing system 100 and the annotation sharing method 600 provide a platform for readers of both the electronic books and paper books to exchange the electronic annotation files and also enhance the reading experiences by increasing the efficiency of fully understanding a book.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fail within the scope of the following claims.

What is claimed is:

1. An annotation sharing system, comprising:
an annotation database storing a plurality of electronic annotation files, wherein each electronic annotation file is associated with a note author identification and an electronic book identification, and the electronic annotation files comprise one or more data entries of one or more data types; and
an annotation management server, electrically connected to the annotation database and a client device, and executes software for performing steps comprising:
providing a visual representation of the electronic annotation files together with the note author identifications and relevant information of the electronic book identified by the electronic book identifications associated with the electronic annotation files to the client device;
receiving a download request from the client device for one or more of the electronic annotation files;
providing a first graphical user interface to the client device for displaying the at least one electronic annotation files associated with the same electronic book identification and an electronic book file identified by the electronic book identification associated with the electronic annotation files, wherein each data entry in the electronic annotation files is represented with a customized visual cue according to the data type of the data entry; and
providing a second graphical interface to the client device for creating and editing the electronic annotation files.

2. The annotation sharing system as claimed in claim 1, wherein the annotation database stores the electronic annotation files comprising the data entries, the data entries comprise page data entries associated with one or more locations in electronic book files identified by the electronic book identifications associated with the electronic annotation files, and the data types for the page data entries comprise image, audio, text, highlight, web link, and error correction.

3. The annotation sharing system as claimed in claim 2, wherein the customized visual cue for the data type of highlight is color, and the customized visual cues for the other data types of the page data entries are icons.

4. The annotation sharing system as claimed in claim 2, wherein the annotation management server executes the software for performing the step of adjusting the first graphical user interface to selectively display part of the electronic book file associated with the page data entries of the data type of highlight.

5. The annotation sharing system as claimed in claim 1, wherein the annotation database stores the electronic annotation files comprising the data entries, and the data entries comprise one or more general data entries with the data types comprising summary, comment, learning map, and sample question.

6. The annotation sharing system as claimed in claim 5, wherein the data entries of the data type of learning map comprise preliminary reading lists and extended reading lists.

7. The annotation sharing system as claimed in claim 1, wherein the annotation management server executes the software for performing the step of receiving a note author identification filter rule to adjust the visual representation and the first graphical user interface according to the note author identifications.

8. The annotation sharing system as claimed in claim 1, wherein the annotation management server executes the software for performing the step of receiving the download request and payment information when the electronic annotation file associated with the download request is priced.

9. The annotation sharing system as claimed in claim 1, wherein the annotation management server executes the software for performing the step of receiving a score from the client device to rate one of the electronic annotation files, and storing the score in the annotation database together with the electronic annotation file.

10. The annotation sharing system as claimed in claim 9, wherein the annotation management server executes the software for performing the step of receiving a rating filter rule to adjust the visual representation and the first graphical user interface according to the scores associated with the electronic annotation files.

11. The annotation sharing system as claimed in claim 1, wherein the annotation management server executes the software for performing the step of receiving a lookup request comprising one of the electronic book identifications and a page image of a paper book identified by the electronic book identification, and recognizing the content of the page image to retrieve and display the page data entries of the annotation files associated with the electronic book identification of the lookup request.

12. An annotation sharing method, comprising:
storing a plurality of electronic annotation files in an annotation database, wherein each electronic annotation file is associated with a note author identification and an electronic book identification, and the electronic annotation files comprise one or more data entries of one or more data types;
providing a visual representation of the electronic annotation files along with the note author identifications and relevant information of the electronic book identified by the electronic book identifications associated with the electronic annotation files to the client device;
receiving a download request from the client device for one or more of the electronic annotation files;
providing a first graphical user interface to the client device for displaying the one or more electronic annotation files associated with the same electronic book identification and an electronic book file identified by the electronic book identification associated with the electronic annotation files, wherein each data entry in the electronic annotation files is represented with a customized visual cue according to the data type of the data entry; and
providing a second graphical interface to the client device for creating and editing the electronic annotation files.

13. The annotation sharing method as claimed in claim 12, wherein the data entries comprise page data entries associated with one or more locations in electronic book files identified by the electronic book identifications associated with the electronic annotation files, and the data types for the page data entries comprise image, audio, text, highlight, web link, and error correction.

14. The annotation sharing method as claimed in claim 13, wherein the customized visual cue for the data type of highlight is color, and the customized visual cues for the other data types of the page data entries are icons.

15. The annotation sharing system as claimed in claim 13, further comprising:
adjusting the first graphical user interface to selectively display part of the electronic book file associated with the page data entries of the data type of highlight.

16. The annotation sharing system as claimed in claim 12, wherein the data entries comprise one or more general data entries with the data types comprising summary, comment, learning map, and sample question.

17. The annotation sharing system as claimed in claim 16, wherein the data entries of the data type of learning map comprise preliminary reading lists and extended reading lists.

18. The annotation sharing system as claimed in claim 12, further comprising:
receiving a note author identification filter rule to adjust the visual representation and the first graphical user interface according to the note author identifications.

19. The annotation sharing system as claimed in claim 12, further comprising:
receiving payment information when the electronic annotation file associated with the download request is priced.

20. The annotation sharing system as claimed in claim 12, further comprising:
receiving a score from the client device to rate one of the electronic annotation files, and storing the score in the annotation database together with the electronic annotation file.

21. The annotation sharing system as claimed in claim 20, further comprising:
receiving a rating filter rule to adjust the visual representation and the first graphical user interface according to the scores associated with the electronic annotation files.

22. The annotation sharing system as claimed in claim 12, further comprising:
receiving an lookup request comprising one of the electronic book identifications and a page image of a paper book identified by the electronic book identification, and recognizing the content of the page image to retrieve and display the page data entries of the annotation files associated with the electronic book identification of the lookup request.
